(19) United States
(12) Patent Application Publication
(10) Pub. No.: US 2026/0202607 A1
(43) Pub. Date: Jul. 16, 2026

(54) OPTICAL FIBER

(71) Applicant: SUMITOMO ELECTRIC INDUSTRIES, LTD., Osaka (JP)

(72) Inventors: Shota TOKAJI, Osaka (JP); Takashi FUJII, Osaka (JP); Kumiko TACHIBANA, Osaka (JP)

(21) Appl. No.: 19/134,439

(22) PCT Filed: Nov. 8, 2023
(86) PCT No.: PCT/JP2023/040216

§ 371 Date: May 30, 2025

(30) Foreign Application Priority Data
Dec. 5, 2022 (JP) 2022-194069

(51) Int. Cl. G02B 6/02; C03C 25/105

(52) U.S. Cl. CPC G02B 6/02395; C03C 25/105

(57) ABSTRACT

An optical fiber includes a glass fiber and a coating resin layer coating the glass fiber. In a differential molecular weight distribution curve obtained by gel permeation chromatography for an extraction liquid obtained by extracting the optical fiber using tetrahydrofuran with a horizontal axis being a logarithmic value log M of a molecular weight M and a vertical axis being dw/d log M obtained by differentiating a concentration fraction w with the log M, when an extremum satisfying conditions (A) and (B) is defined as a satisfying extremum, a number of satisfying extrema is 4 or less: (A) the extremum is in a molecular weight range of 3.5≤log M≤5.5; and (B) when a maximum value of dw/d log M in the molecular weight range is 1, a difference in dw/d log M between the extremum and another extremum adjacent to the extremum is 0.15 or more.

### TECHNICAL FIELD

The present disclosure relates to an optical fiber. This application claims priority from Japanese Patent Application No. 2022-194069 filed on Dec. 5, 2022, the entire contents of which are incorporated herein by reference.

### BACKGROUND ART

In general, an optical fiber has a glass fiber and a protective coating layer for protecting the glass fiber. Patent literature 1 describes that in a glass fiber having a plurality of protective coating layers, when the Young's modulus of the protective coating layer in contact with the glass fiber is small, the lateral pressure characteristics are easily improved.

### CITATION LIST

### Patent Literature

Patent literature 1: WO 2016/088801 A1

### SUMMARY OF INVENTION

An optical fiber according to an embodiment of the present disclosure is an optical fiber including a glass fiber and a coating resin layer coating the glass fiber. In a differential molecular weight distribution curve obtained by gel permeation chromatography for an extraction liquid obtained by extracting the optical fiber using tetrahydrofuran with a horizontal axis being a logarithmic value log M of a molecular weight M and a vertical axis being dw/d log M obtained by differentiating a concentration fraction w with the logarithmic value log M of the molecular weight, a number of extrema satisfying both of conditions (A) and (B) is 4 or less:
(A) the extremum is in a molecular weight range of 3.5≤log M≤5.5; and
(B) when a maximum value of dw/d log M in the molecular weight range is 1, a difference in dw/d log M between the extremum and an extremum adjacent to the extremum is 0.15 or more.

### BRIEF DESCRIPTION OF DRAWINGS

FIG. 1 is a cross-sectional view showing an example of an optical fiber according to the embodiment.

FIG. 2 is a differential molecular weight distribution curve obtained by gel permeation chromatography of the optical fiber according to the example.

FIG. 3 is a differential molecular weight distribution curve obtained by gel permeation chromatography of the optical fiber according to the comparative example.

### DESCRIPTION OF EMBODIMENTS

### Problems to be Solved by Present Disclosure

When the Young's modulus of the protective coating layer in contact with the glass fiber is small, voids and cracks are likely to be generated in the protective coating layer in a low-temperature environment in which the protective coating layer is likely to contract, and the transmission loss tends to increase. Thus, an optical fiber that reduces the increase in transmission loss in a low-temperature environment is desired.

An object of the present disclosure is to provide an optical fiber in which an increase in transmission loss in a low-temperature environment is reduced.

### Advantageous Effects of Present Disclosure

According to the present disclosure, an optical fiber in which an increase in transmission loss in a low-temperature environment is reduced can be provided.

### DESCRIPTION OF EMBODIMENTS OF PRESENT DISCLOSURE

First, embodiments of the present disclosure will be listed and described.

(1) An optical fiber according to an embodiment of the present disclosure includes: an optical fiber including a glass fiber and a coating resin layer coating the glass fiber, in which, in a differential molecular weight distribution curve obtained by gel permeation chromatography for an extraction liquid obtained by extracting the optical fiber using tetrahydrofuran with a horizontal axis being a logarithmic value log M of a molecular weight M and a vertical axis being dw/d log M obtained by differentiating a concentration fraction w with the logarithmic value log M of the molecular weight, a number of extrema satisfying both of conditions (A) and (B) is 4 or less:
(A) the extremum is in a molecular weight range of 3.5≤log M≤5.5; and
(B) when a maximum value of dw/d log M in the molecular weight range is 1, a difference in dw/d log M between the extremum and an extremum adjacent to the extremum is 0.15 or more.

In the optical fiber according to the embodiment, the crosslinking of the coating resin layer progresses in a balanced manner, and voids and cracks are unlikely to occur even in a low-temperature environment. Thus, an optical fiber in which an increase in transmission loss in a low-temperature environment is reduced is obtained.

(2) In the above (1), the coating resin layer may include a primary layer in contact with the glass fiber, and the primary layer may have a Young modulus of 0.6 MPa or less.

In the optical fiber according to the embodiment, since the Young's modulus of the primary layer is small, the lateral pressure resistance characteristics are improved, and an increase in transmission loss in a low-temperature environment can be reduced.

(3) In the above (2), the primary layer may have a thickness of 17.5 μm to 50 μm.

The optical fiber according to the embodiment has a thin primary layer, and thus can be suitably applied to a small-diameter optical fiber.

(4) In any one of (1) to (3), an increase in a transmission loss at −60° C. with respect to a transmission loss at 23° C. may be less than 0.010 dB/km.

In the optical fiber according to the embodiment, the increase in transmission loss in a low-temperature environment is significantly reduced.

### DETAILS OF EMBODIMENTS OF PRESENT DISCLOSURE

Specific examples of the optical fiber according to the embodiments of the present disclosure will be described below with reference to the drawings. The present invention is not limited to these examples, but is defined by the scope of the claims, and is intended to include all modifications within the meaning and scope equivalent to the scope of the claims.

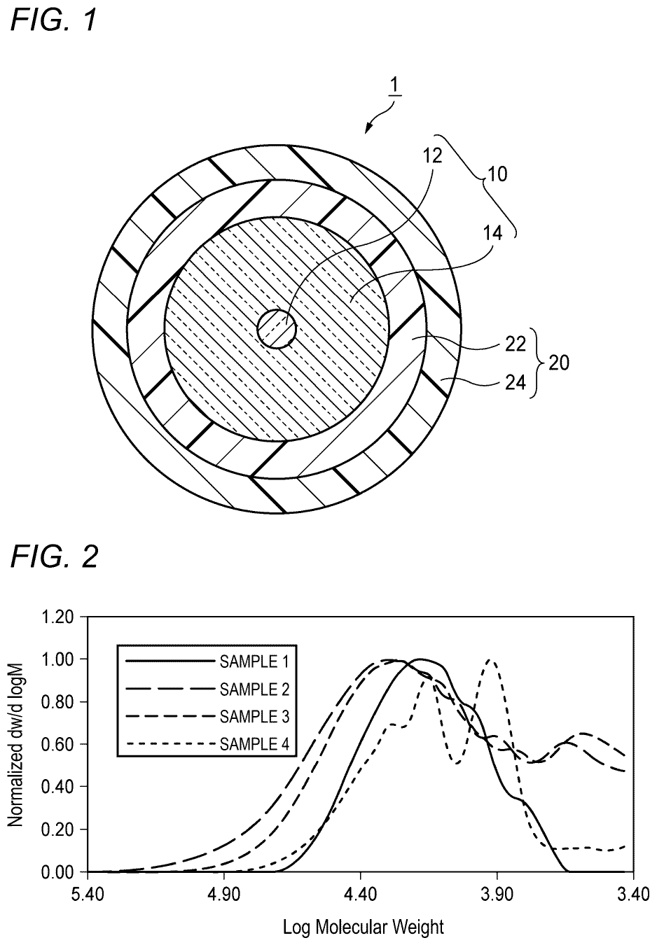

FIG. 1 is a cross-sectional view showing an example of an optical fiber 1 according to the embodiment. As shown in FIG. 1, the optical fiber 1 of the embodiment includes a glass fiber 10 as an optical transmission medium and a coating resin layer 20.

The glass fiber 10 has a core 12 and a cladding 14, and is made of a glass member, for example, SiO₂ glass. The glass fiber 10 transmits the light introduced into the optical fiber 1. The core 12 is provided in a region including the central axis of the glass fiber 10, for example. The core 12 may be made of pure SiO₂ glass or may contain GeO₂, fluorine, or the like. The cladding 14 is provided in a region surrounding the core 12. The cladding 14 has a refractive index lower than the refractive index of the core 12. The cladding 14 may be made of pure SiO₂ glass or fluorine-doped SiO₂ glass.

The diameter of the glass fiber 10 is usually about 125 m. The total thickness of the coating resin layer 20 is preferably 70 μm or less, more preferably 60 μm or less, and still more preferably 42.5 μm or less. The outer diameter of the optical fiber 1 is, for example, 245 μm to 265 μm, 180 μm to 220 μm, or the like.

The coating resin layer 20 is a resin layer that covers the glass fiber 10. The coating resin layer 20 may be composed of a plurality of layers. For example, when the coating resin layer 20 is formed of two layers, as shown in FIG. 1, the coating resin layer 20 is formed of a primary layer 22 in contact with the glass fiber 10 and a secondary layer 24 in contact with the primary layer 22. The number of layers of the coating resin layer 20 is not limited to two, and a third layer serving as an ink layer may be further formed on the outer peripheral surface of the secondary layer 24.

The coating resin layer 20 may be formed by curing an ultraviolet curable resin composition including, for example, an oligomer, a monomer, and a photopolymerization initiator.

Examples of the oligomer include urethane (meth)acrylate and epoxy (meth)acrylate. Two or more kinds of oligomers may be mixed and used.

Examples of the urethane (meth)acrylate include those obtained by reacting a polyol compound, a polyisocyanate compound, and a hydroxyl group-containing acrylate compound. Examples of the polyol compound include polytetramethylene glycol, polypropylene glycol, bisphenol A-ethylene oxide adduct diol, and the like. Examples of the polyisocyanate compound include 2,4-tolylene diisocyanate, 2,6-tolylene diisocyanate, and isophorone diisocyanate. Examples of the hydroxyl group-containing acrylate compound include 2-hydroxy(meth)acrylate, 2-hydroxyethyl (meth)acrylate, 2-hydroxybutyl (meth)acrylate, 1,6-hexanediol mono(meth)acrylate, pentaerythritol tri(meth)acrylate, 2-hydroxypropyl(meth)acrylate, and tripropylene glycol di(meth)acrylate. As the epoxy (meth)acrylate, for example, a product obtained by reacting an epoxy compound with (meth)acrylic acid can be used.

Here, the (meth)acrylate means an acrylate or a methacrylate corresponding thereto. The same applies to (meth)acrylic acid.

The content of the oligomer is preferably 50 mass % to 90 mass %, and more preferably 35 mass % to 85 mass %, based on the total amount of the ultraviolet curable resin composition.

As the monomer, a monofunctional monomer having one polymerizable group or a polyfunctional monomer having two or more polymerizable groups can be used.

Examples of the monofunctional monomer include N-vinyl monomers having a cyclic structure, such as N-vinylpyrrolidone, N-vinylcaprolactam, and (meth)acryloylmorpholine; and (meth)acrylate compounds, such as isobornyl (meth)acrylate, tricyclodecanyl (meth)acrylate, benzyl (meth)acrylate, dicyclopentanyl (meth)acrylate, 2-hydroxyethyl (meth)acrylate, nonylphenyl (meth)acrylate, phenoxyethyl (meth)acrylate, and polypropylene glycol mono(meth)acrylate. Among these, an N-vinyl monomer having a cyclic structure is preferable in view of improving the curing rate.

Examples of the polyfunctional monomer include polyethylene glycol di(meth)acrylate, tricyclodecanediyldimethylene di(meth)acrylate, bisphenol A-ethylene oxide adduct diol di(meth)acrylate, and trimethylolpropane tri(meth)acrylate.

Two or more kinds of monomers may be mixed and used. The content of the monomer is preferably 5 mass % to 45 mass %, and more preferably 10 mass % to 30 mass %, based on the total amount of the ultraviolet curable resin composition.

The photopolymerization initiator can be appropriately selected from known radical photopolymerization initiators and used, and examples thereof include an acylphosphine oxide-based initiator and an acetophenone-based initiator.

Examples of the acylphosphine oxide-based initiator include 2,4,6-trimethylbenzoyl diphenylphosphine oxide (manufactured by IGM Resins B.V., product name: Omnirad TPO H), 2,4,4-trimethylpentylphosphine oxide, and 2,4,4-trimethylbenzoyl diphenylphosphine oxide.

Examples of the acetophenone-based initiator include 1-hydroxycyclohexan-1-yl phenyl ketone (manufactured by BASF, product name: “Irgacure 184”), 2-hydroxy-2-methyl-1-phenyl-propan-1-one (manufactured by BASF, product name: “Darocur 1173”), 2,2-dimethoxy-1,2-diphenylethan-1-one (manufactured by BASF, product name: “Irgacure 651”), 2-methyl-1-(4-methylthiophenyl)-2-morpholinopropan-1-one (manufactured by BASF, product name: “Irgacure 907”), 2-benzyl-2-dimethylamino-1-(4-morpholinophenyl)-butanone-1 (manufactured by BASF, product name: “Irgacure 369”), 1-hydroxycyclohexyl phenyl ketone, 2,2-dimethoxy-2-phenyl acetophenone, and 1-(4-isopropylphenyl)-2-hydroxy-2-methylpropan-1-one.

Two or more kinds of photopolymerization initiators may be mixed and used. The content of the photopolymerization initiator is preferably 0.1 mass % to 10 mass %, and more preferably 0.3 mass % to 7 mass %, based on the total amount of the ultraviolet curable resin composition.

When the coating resin layer 20 includes the primary layer 22 in contact with the glass fiber 10, the primary layer 22 may have a Young's modulus of 0.6 MPa or less. When the primary layer 22 has the Young's modulus of 0.6 MPa or less, the lateral pressure resistance characteristics of the optical fiber 1 is improved. The primary layer 22 may have the Young's modulus of 0.5 MPa or less, or 0.4 MPa or less. The lower limit of the Young's modulus of the primary layer 22 is not particularly limited, but may be, for example, 0.05 MPa or more. The Young's modulus in the present disclosure is measured at normal temperature (23° C.) by a pullout modulus (POM) method, and specifically, is obtained by a method described in Examples described later.

The primary layer 22 may have a thickness of 17.5 μm to 50 μm. When the thickness of the primary layer 22 is within the above range, the primary layer 22 can be suitably applied to a small-diameter optical fiber.

When the coating resin layer 20 has the secondary layer 24 in contact with the outer surface of the primary layer 22, the Young's modulus of the secondary layer 24 is preferably 600 MPa or more at 23° C. from the viewpoint of mechanical strength for protecting the glass fiber 10. The Young's modulus of the secondary layer 24 is more preferably 800 MPa or more, and still more preferably 1000 MPa or more. The upper limit of the Young's modulus of the secondary layer 24 is not particularly limited, and may be, for example, 1600 MPa or less.

The optical fiber 1 of the present embodiment has the following configuration. In a differential molecular weight distribution curve obtained by gel permeation chromatography for an extraction liquid obtained by extracting the optical fiber 1 using tetrahydrofuran with a horizontal axis being a logarithmic value log M of a molecular weight M and a vertical axis being dw/d log M obtained by differentiating a concentration fraction w with the logarithmic value log M of the molecular weight, a number of extrema satisfying both of conditions (A) and (B) is 4 or less:
(A) the extremum is in a molecular weight range of 3.5≤log M≤5.5; and
(B) When a maximum value of dw/d log M in the molecular weight range is 1, a difference in dw/d log M between the extremum and an extremum adjacent to the extremum is 0.15 or more. Here, the extrema include both the local maximum value and the local minimum value. In addition, when only one local maximum value exists as in the normal distribution and “an extremum adjacent to the extremum” defined by the condition (B) does not exist, the number of extrema satisfying both of the conditions (A) and (B) is one.

When the number of extrema satisfying both of the conditions (A) and (B) is 4 or less, the crosslinking of the coating resin layer 20 proceeds in a balanced manner, and voids and cracks are less likely to occur in the coating resin layer 20 even in a low-temperature environment. Thus, the optical fiber 1 in which the increase in transmission loss in a low-temperature environment is reduced is obtained.

As defined in condition (A), the number of extrema in the molecular weight range of 3.5≤log M≤5.5 is counted. The reason for such a definition is that the molecular weight distribution in the molecular weight range is considered to be a molecular weight distribution derived from the oligomer which is the raw material of the coating resin layer 20. As will be described later, it is considered that the molecular weight distribution of the oligomer is related to the crosslinked structure of the coating resin layer 20. Unless otherwise specified, the terms “logarithmic value” and “log” in the present disclosure mean common logarithm.

As defined in condition (B), when the maximum value of dw/d log M in the molecular weight range is set to 1, the number of extrema having a difference in dw/d log M between the extremum and an extremum adjacent to the extremum of 0.15 or more is counted. The “extremum adjacent to the extremum” is an extremum in the molecular weight range of 3.5≤log M≤5.5. That is, “adjacent extremum” existing outside the molecular weight range is not considered. When there are two extrema adjacent to the extremum within the molecular weight range, “the difference in dw/d log M between the extremum and an extremum adjacent to the extremum is 0.15 or more” means that the difference in dw/d log M between the extremum and each of the two extrema adjacent to the extremum is 0.15 or more.

The reason for defining condition (B) is as follows. In the molecular weight distribution curve, a small peak may be generated depending on a minor component contained in the measurement target. When an extremum having a small difference in dw/d log M from an adjacent extremum is counted, a small peak due to a minor component is counted as one extremum, and as a result, even substantially the same molecular weight distribution curve may have a different number of extrema depending on the presence or absence of a minor component. In order to remove the influence of such a minor component, only the extremum having a difference in dw/d log M from the adjacent extremum equal to or larger than a predetermined value is counted.

The following reasons are assumed as specific reasons why the increase in transmission loss in a low-temperature environment is reduced when the number of extrema satisfying both of the conditions (A) and (B) is 4 or less. In the optical fiber 1 of the embodiment, the number of extrema in the molecular weight range of 3.5≤log M≤5.5, which is considered to be derived from the oligomer in the molecular weight distribution curve is small, and the oligomer is uniformly distributed from the oligomer having a large number of repetitions (large molecular weight) to the oligomer having a small number of repetitions (small molecular weight). Thus, crosslinking proceeds in a balanced manner when the coating resin layer 20 is formed, and a dense crosslinked structure is formed. As a result, it is considered that voids and cracks are less likely to occur in the coating resin layer 20 even in a low-temperature environment. When the number of extrema in the molecular weight range of 3.5≤log M≤5.5 is large, the molecular weight distribution is not uniform, for example, a large amount of oligomers having a specific molecular weight are present, whereas only a small amount of oligomers having a specific molecular weight are present. If the molecular weight distribution of the oligomer is not uniform, a dense crosslinked structure cannot be formed when the coating resin layer 20 is formed, and a portion where the crosslinking is sparse is likely to be generated. As a result, it is considered that voids and cracks are likely to occur in the coating resin layer 20 in a low-temperature environment, and the transmission loss increases greatly.

From the viewpoint of reducing an increase in transmission loss in a low-temperature environment, the number of extrema satisfying both of the conditions (A) and (B) may be three or less, or may be one or less.

In order to set the number of extrema satisfying both of the conditions (A) and (B) to four or less, it is preferable to use a raw material having a wide molecular weight distribution as the raw material of the oligomer. For example, when urethane (meth)acrylate is used as the oligomer, a polyol compound having a wide molecular weight distribution can be used as a raw material for the urethane (meth)acrylate. The term “wide molecular weight distribution” as used herein means that a polydispersity (Mw/Mn), which is the ratio of a weight-average molecular weight Mw to a number-average molecular weight Mn, is large.

In order to set the number of extrema satisfying both of the conditions (A) and (B) to four or less, it is necessary that the curing of the coating resin layer 20 has sufficiently proceeded. If the curing does not proceed sufficiently, the number of extrema satisfying both of the conditions (A) and (B) may increase.

The optical fiber 1 may have an increase in transmission loss at −60° C. with respect to transmission loss at 23° C. of less than 0.010 dB/km. When the increase in transmission loss at −60° C. is within this range, the increase in transmission loss in a low-temperature environment is significantly reduced. The increase in transmission loss at −60° C. is a value measured by, for example, the method described in Examples.

### EXAMPLES

The present disclosure will be described in detail with reference to the following examples, but the present invention is not limited to these examples.

### [Preparation of Resin Composition for Primary Layer]

### Preparation Example A1

A urethane (meth)acrylate oligomer was synthesized using polypropylene glycol having a number-average molecular weight of 2000 as a polyol compound, 2,4-tolylene diisocyanate as a polyisocyanate compound, and 2-hydroxyethyl acrylate as a hydroxyl group-containing (meth)acrylate compound. The obtained urethane (meth)acrylate oligomer, nonylphenyl acrylate as a monomer, and TPO (manufactured by IGM Resins B.V, product name: Omnirad TPO H) as a photopolymerization initiator were mixed to prepare a resin composition for primary layer A1.

### Preparation Examples A2 to A6

The resin compositions for primary layer A2 to A6 were prepared in the same manner as in Preparation Example A1, except that polypropylene glycol having a molecular weight distribution different from that of the polypropylene glycol used in the Preparation Example A1 was used as the polyol compound.

### [Preparation of Resin Composition for Secondary Layer]

### Preparation Example B1

A urethane (meth)acrylate oligomer was synthesized using polypropylene glycol having a number-average molecular weight of 2000 as a polyol compound, 2,4-tolylene diisocyanate as a polyisocyanate compound, and 2-hydroxyethyl acrylate as a hydroxyl group-containing (meth)acrylate compound. The obtained urethane (meth)acrylate oligomer, tripropyleneglycol diacrylate as a monomer, and TPO (manufactured by IGM Resins B.V, product name: Omnirad TPO H) as a photopolymerization initiator were mixed to prepare a resin composition for secondary layer B1.

### [Production of Optical Fiber]

### (Sample 1)

A primary layer having a thickness of 35 μm was formed on the outer periphery of a glass fiber having a diameter of 125 μm and composed of a core and a cladding, using the resin composition for primary A1. Further, a secondary layer having a thickness of 30 μm was formed on the outer periphery of the primary layer using the resin composition for secondary B1, thereby producing an optical fiber having a diameter of 245 μm.

### (Samples 2 to 6)

Optical fibers were produced in the same manner as in Sample 1 except that A2 to A6 were used instead of A1 as the resin composition for primary layer.

### [Evaluation of Optical Fiber]

For each of the optical fibers produced in Samples 1 to 6, the molecular weight distribution, the Young's modulus of the primary layer and the secondary layer, and the amount of increase in low-temperature transmission loss were measured by the following methods.

### (Molecular Weight Distribution)

For each optical fiber, the organic layer was extracted with a tetrahydrofuran (TIF) solution, and the molecular weight distribution was measured by gas permeation chromatography of the extraction liquid. The specific analysis conditions are as follows.
Analytical instrument: AC QUITY APC RI system from Waters
Sample concentration: 0.2 mass %
THF solution injection amount: 20 μL
Sample temperature: 15° C.
Mobile phase: THF
XT column for organic solvents: particle size 2.5 μm, pore size 45 nm, column internal diameter 4.6×column length 150 mm+particle size 2.5 μm, pore size 12.5 nm, column internal diameter 4.6×column length 150 mm+particle size 1.7 μm, pore size 4.5 nm, column internal diameter 4.6×column length 150 mm
Column temperature: 40° C.
Flow rate: 0.8 mL/min
Standard sample: polystyrene

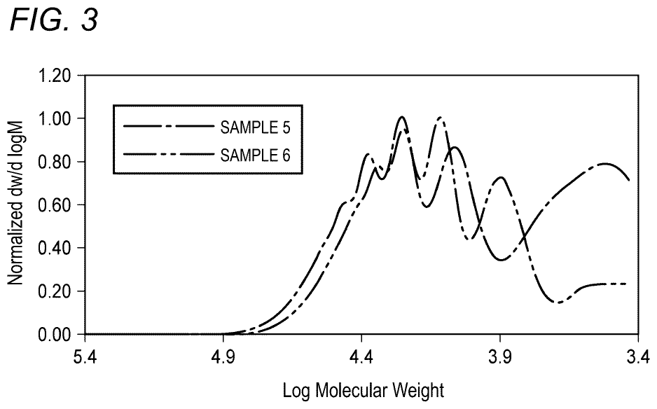

Table 1 shows the number of extrema satisfying both of the conditions (A) and (B), the number-average molecular weight Mn, the weight-average molecular weight Mw, and the polydispersity Mw/Mn for each optical fiber. Examples 1 to 4 are examples, and Samples 5 and 6 are comparative examples. FIGS. 2 and 3 show differential molecular weight distribution curves obtained by measuring the molecular weight distribution of each optical fiber. FIG. 2 shows the differential molecular weight distribution curves of Samples 1 to 4, and FIG. 3 shows the differential molecular weight distribution curves of Samples 5 and 6, which are comparative samples. The vertical axis in FIGS. 2 and 3 shows the value of dw/d log M of each curve in the molecular weight range of 3.5≤log M≤5.5, when the maximum value is one.

### (Young Modulus)

The Young's modulus of each coating resin layer (primary layer and secondary layer) of the optical fiber at room temperature (23° C.) was measured by a pullout modulus (POM) method. Two portions of the optical fiber were fixed by two chuck devices, and a portion of the coating resin layer between the two chuck devices was removed. Then, one chuck device was fixed, and the other chuck device was gently moved in the direction opposite to the fixed chuck device. When the length of the portion of the optical fiber sandwiched by the chuck device to be moved is L, the amount of movement of the chuck is Z, the outer diameter of the coating resin layer (primary layer or secondary layer) to be measured is Dp, the outer diameter of the glass fiber is Df, the Poisson's ratio of the coating resin layer to be measured is n, and the load during movement of the chuck device is W, the Young's modulus (POM value) of the coating resin layer to be measured was obtained from the following equation.

Young's modulus (MPa)=((1+n)W/πLZ)×ln(Dp/Df)

Table 1 shows the measurement results of the Young's modulus of the primary layer and the secondary layer of each optical fiber.

### (Low-Temperature Transmission Loss Increase Amount)

The transmission loss of light with a wavelength of 1550 nm of an optical fiber subjected to a screening tension of 2 kg was measured at 23° C., and then the optical fiber was placed in an environment of −40° C. or −60° C. for 2 hours, and the transmission loss of light with a wavelength of 1550 nm was measured. The increase in the transmission loss of the optical fiber after being placed at −40° C. (or −60° C.) relative to the optical fiber before being placed at −40° C. (or −60° C.) was defined as the increase in the low-temperature transmission loss. The measurement results of the increase in the low-temperature transmission loss of each optical fiber are shown in Table 1.

TABLE 1

| | | ITEM | | | | | |
|---|---|---|---|---|---|---|---|
| | | SAMPLE | SAMPLE | SAMPLE | SAMPLE | SAMPLE | SAMPLE |
| | | 1 | 2 | 3 | 4 | 5 | 6 |
| NUMBER OF EXTREMA | | 1 | 1 | 1 | 3 | 5 | 5 |
| SATISFYING BOTH OF | | | | | | | |
| CONDITIONS (A) AND (B) | | | | | | | |
| MOLECULAR | Mn | 8350 | 10527 | 9542 | 11674 | 8350 | 11247 |
| WEIGHT | Mw | 16200 | 23177 | 19085 | 16884 | 16200 | 17578 |
| | Mw/Mn | 1.940 | 2.202 | 2.000 | 1.446 | 1.940 | 1.563 |
| YOUNG'S MODULUS OF | | 0.50 | 0.30 | 0.47 | 0.41 | 0.30 | 0.80 |
| PRIMARY LAYER [MPa] | | | | | | | |
| YOUNG'S MODULUS OF | | 900 | 840 | 927 | 1089 | 1050 | 955 |
| SECONDARY LAYER [MPa] | | | | | | | |
| LOW- | −40° C. | 0.000 | 0.003 | 0.003 | 0.003 | 0.006 | 0.007 |
| TEMPERATURE | | | | | | | |
| TRANSMISSION | | | | | | | |
| LOSS INCREASE | −60° C. | 0.002 | 0.005 | 0.006 | 0.007 | 0.010 | 0.013 |
| AMOUNT [dB/km] | | | | | | | |

As can be seen from Table 1, the optical fiber in which the number of extrema satisfying the conditions (A) and (B) is 4 or less has an increase in low-temperature transmission loss of less than 0.010 dB/km before and after being placed at −60° C., and the increase in transmission loss in a low-temperature environment is reduced.

### REFERENCE SIGNS LIST

1: optical fiber
10: glass fiber
12: core
14: cladding
20: coating resin layer
22: primary layer
24: secondary layer

What is claimed is:

1. An optical fiber comprising a glass fiber and a coating resin layer coating the glass fiber,
wherein, in a differential molecular weight distribution curve obtained by gel permeation chromatography for an extraction liquid obtained by extracting the optical fiber using tetrahydrofuran with a horizontal axis being a logarithmic value log M of a molecular weight M and a vertical axis being dw/d log M obtained by differentiating a concentration fraction w with the logarithmic value log M of the molecular weight, when an extremum satisfying both of conditions (A) and (B) is defined as a satisfying extremum, a number of satisfying extrema is 4 or less:
(A) the extremum is in a molecular weight range of 3.5≤log M≤5.5; and
(B) when a maximum value of dw/d log M in the molecular weight range is 1, a difference in dw/d log M between the extremum and another extremum adjacent to the extremum is 0.15 or more.

2. The optical fiber according to claim 1, wherein
the coating resin layer includes a primary layer in contact with the glass fiber, and
the primary layer has a Young modulus of 0.6 MPa or less.

3. The optical fiber according to claim 2, wherein
the primary layer has a thickness of 17.5 μm to 50 μm.

4. The optical fiber according to claim 1, wherein
an increase in a transmission loss at −60° C. with respect to a transmission loss at 23° C. is less than 0.010 dB/km.
